(19) United States
(12) Patent Application Publication
(10) Pub. No.: US 2004/0113886 A1
(43) Pub. Date: Jun. 17, 2004

(54) Sensing structure for optic input

(76) Inventor: Chia Hsiang Lee, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/316,010

(22) Filed: Dec. 11, 2002

(51) Int. Cl. G09G 5/00

(52) U.S. Cl. 345/156

(57) ABSTRACT

A sensing structure for optic inputs is embodied in a computer mouse or a touch pad. The sensing structure includes a light source for emitting a light toward an operation surface on which the mouse moves or a finger moving on the touch pad. The light is reflected by the operation surface or the finger toward a lens and is focused by the lens onto a sensor chip to be detected thereby. The light source is located adjacent the lens whereby light from the light source can be directly projected onto the operation surface or the finger. The light does not need to travel through transparent body to be redirected thereby toward the operation surface. This alleviates attenuation of the light from the light source and detection sensitivity and correctness are enhanced.

### BACKGROUND OF THE INVENTION

1. Field of the Invention

The present invention generally relates to a sensing structure for optic inputs, and in particular to a simple sensing structure for optic inputs.

2. The Related Art

Optic input devices for computers, such as an optic computer mouse, comprise a sensor chip and a plurality of light sources for projecting light beams onto an operation surface on which the mouse is moved. Light reflected from the operation surface is detected by the sensor chip and signals associated with the reflected light are then processed to provide moving vector and coordinates of the mouse. Thus, the movement of the mouse is converted into movement of a cursor on a display screen.

FIG. 1 of the attached drawings shows a conventional sensing structure for optic input device, comprising a sensor chip 10 retained in position by a mount 11 that is in turned secured on a bottom 15 of an optic mouse, which is positioned on and movable along an operation surface 16. A transparent body forming a lens 13 is mounted on the bottom 15 with the lens 13 corresponding to the sensor chip 10 in spatial position. A light source 14 is fixed inside the mouse for giving off light. The transparent body forms a number of reflection/refraction surface for redirecting the light from the light source 14 toward the operation surface 16. The light is reflected by the operation surface 16 onto the lens 13 that focus the reflected light toward the sensor chip 10. Movement of the mouse along the operation surface 16 is thus detected by the sensor chip 10 that detects the light reflected from the operation surface.

The conventional design requires the light emitted from the light source to transmit through the transparent body and thus reflected/refracted by surfaces of the transparent body. Transmitting through the transparent body leads to attenuation or deterioration of the light whereby the light reflected from the operation surface may not be correctly detected by the sensor chip 10. Incorrect movement of a cursor on the display screen may thus be induced and thus correct positioning of the cursor is difficult. Further, the complicated configuration of the lens or the transparent body increases the overall size of the optic mouse.

Thus, it desired to have a sensing structure for optic inputs that alleviates the above problems.

### SUMMARY OF THE INVENTION

An object of the present invention is to provide a sensing structure for optic inputs that reduces signal attenuation by directly projecting light toward an operation surface.

Another object of the present invention is to provide a sensing structure for optic inputs that has a simple configuration to reduce the overall size thereof.

A further object of the present invention is to provide a simple and size-reduced sensing structure for optic inputs that can be embodied in different devices, such as a touch pad.

To achieve the above objects, in accordance with the present invention, there is provided a sensing structure for optic inputs, embodied in a computer mouse or a touch pad, comprising a light source for emitting a light toward an operation surface on which the mouse moves or a finger moving on the touch pad. The light is reflected by the operation surface or the finger toward a lens and is focused by the lens onto a sensor chip to be detected thereby. The light source is located adjacent the lens whereby light from the light source can be directly projected onto the operation surface or the finger. The light does not need to travel through transparent body to be redirected thereby toward the operation surface. This alleviates attenuation of the light from the light source and detection sensitivity and correctness are enhanced.

### BRIEF DESCRIPTION OF THE DRAWINGS

The present invention will be apparent to those skilled in the art by reading the following description of preferred embodiment thereof, with reference to the attached drawings, in which:

FIG. 1 is a cross-sectional view of a conventional sensing structure for optic inputs;

FIG. 2 is a cross-sectional view of a sensing structure for optic inputs in accordance with the present invention;

FIG. 3 is a cross-sectional view of a sensing structure for optic inputs in accordance a different embodiment of the present invention; and

FIG. 4 is a cross-sectional view of the sensing structure embodied in a different optic input device.

### DETAILED DESCRIPTION OF THE PREFERRED EMBODIMENTS

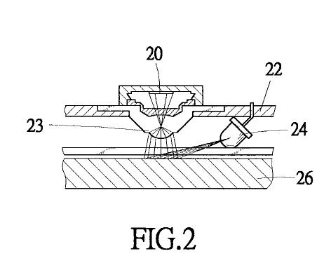

With reference to the drawings and in particular to FIG. 2, a sensing structure for optic inputs constructed in accordance with the present invention comprises a sensor chip 20 mounted to a circuit board 22. A lens 23 is positioned in front of the sensor chip 20 for focusing external light onto the sensor chip 20. A light source 24, such as a light emitting diode (LED), is mounted to the circuit board 22 in the proximity of the sensor chip 20.

The sensing structure that may be embodied in a computer mouse (not shown) is movable on an operation surface 26. The light source 24 is positioned so that light from the light source 24 is directly projected onto the operation surface 26. In the embodiment illustrated, the light source 24 is positioned under the circuit board 22 and close to the lens 23. Light reflected from the operation surface 26 is focused onto the sensor chip 20 by the lens 23, as shown in FIG. 2. Since light traveling through a transparent body for being redirected toward the operation surface is not needed, attenuation of the light caused by light traveling through the transparent body is thus completely eliminated. In addition, since the light source 24 is positioned close to the sensor chip 20, the overall size of the sensing structure is reduced.

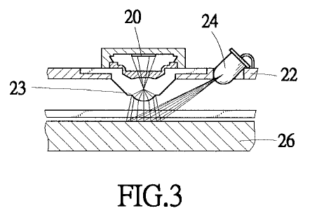

Referring to FIG. 3, a sensing structure constructed in accordance with another embodiment of the present invention is shown, which is a modification of the sensing structure shown in FIG. 2, wherein the light source 24 is mounted on a top side of the circuit board 22 and an opening (not labeled) is defined in the circuit board 22 to allow for direct projection of the light from the light source 24 onto the operation surface 26 that is below the circuit board 22. The light is reflected by the operation surface 26 toward the lens 23 and focused by the lens 23 onto the sensor chip 20. Again, the light source 24 is adjacent the lens 23 and the sensor chip 20 whereby the light emitted from the light source does not travel through the lens or any transparent body before the light reaches the operation surface 26.

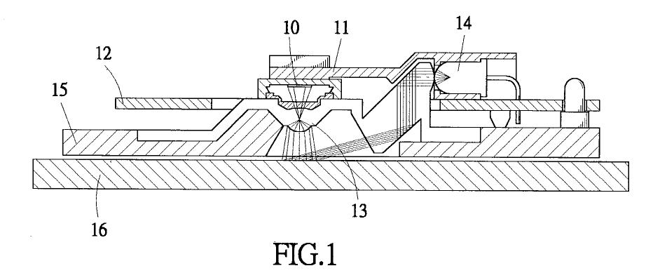

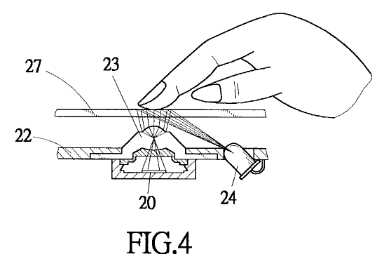

In the embodiments illustrated in FIGS. 2 and 3, the sensing structure is embodied in a computer mouse wherein the operation surface is located below the circuit board in normal operation conditions but FIG. 4 shows a different application of the sensing structure of the present invention in which the sensing structure is embodied in a touch pad, rather than a computer mouse. The sensing structure is installed in an up-side-down manner as compared to the embodiments of FIGS. 1 and 2. A transparent plate 27 is positioned above the light source 24 and the lens 23 to replace the operation surface 26 of the embodiments shown in FIGS. 1 and 2 and an external object, such as a user's finger, is moved on the transparent plate 27 for controlling the movement of a cursor associated therewith. Thus, the plate 27 is located between the finger and the light source 24. A light emitted from the light source 24 mounted on a circuit board 22 is directly projected onto and transmits through the transparent surface 27. The light is reflected by the finger and transmits through the plate 27 again. The reflected light is then focused onto the sensor chip 20 by the lens 23. The movement of the finger is converted into movement of cursor on a computer display.

In accordance with the present invention, the light source of an optic sensing device is arranged adjacent to the sensor chip and light from the light source does not need to travel through any media rather than air before it reaches an operation surface. This alleviates incorrect detection caused by attenuation of the light from the light source.

Since the structure is simplified, the overall size of the sensing structure of the present invention is reduced. The reduction of the size allows the sensing structure of the present invention to be incorporated in other optic sensing device, such as a touch pad, enhancing flexibility of the sensing structure.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A sensing structure for optic inputs adapted to be positioned adjacent to an external object, the sensing structure comprising a light source for emitting a light toward the external object, the light reflected by the external object toward a lens and focused by the lens onto a sensor chip to be detected thereby, wherein the light source is arranged to directly project the light onto the external object to be reflected thereby.

2. The sensing structure as claimed in claim 1 further comprising a circuit board on which the light source is mounted.

3. The sensing structure as claimed in claim 2, wherein the circuit board is arranged so that the external object is located below the circuit board, the light source being mounted under the circuit board to directly project the light onto the external object.

4. The sensing structure as claimed in claim 2, wherein the circuit board is arranged so that the external object is located below the circuit board, the light source being mounted above the circuit board and an opening being defined in the circuit board to allow light emitted from the light source to be directly projected onto the external object.

5. The sensing structure as claimed in claim 1 further comprising a transparent plate arranged between the light source and the external object to support movement of the external object thereon.

6. The sensing structure as claimed in claim 1, wherein the sensing structure in embodied in a computer mouse.

7. The sensing structure as claimed in claim 5, wherein the sensing structure in embodied in a touch pad.
